(19) United States
(12) Patent Application Publication
(10) Pub. No.: US 2007/0184768 A1
(43) Pub. Date: Aug. 9, 2007

(54) Breakaway poultry shackle

(76) Inventors: William Sorensen, Blue Springs, MO (US); Joshua Gillespie, Gladstone, MO (US)

Correspondence Address: SPENCER, FANE, BRITT & BROWNE, 1000 WALNUT STREET, SUITE 1400, KANSAS CITY, MO, 64106-2140, US

(21) Appl. No.: 11/343,181

(22) Filed: Jan. 30, 2006

(51) Int. Cl. A22B 7/00

(52) U.S. Cl. 452/189

(57) ABSTRACT

A shackle for retaining and associating a carcass, such as, for example, a poultry carcass, with a conveyor system for transporting the carcass along a processing line. The shackle includes a disengagement, or breakaway, feature in which at least a portion of the shackle carrying the carcass automatically disengages from the conveyor system under a pre-established condition involving an increase in downward force, such as, for example, when the shackle becomes caught or otherwise impeded. The disengagement is accomplished by the opening, or separation, of bendable arms in response to the downward force created by the caught or impeded shackle, which creates or widens a gap between the arms that, in turn, causes the at least a portion of the shackle to be released. Once the shackle is disengaged, the conveyor can resume normal travel along the processing line, and processing operations can continue.

### BACKGROUND OF THE INVENTION

1. Field of the Invention

The present invention relates to devices for retaining and associating carcasses, particularly poultry carcasses, with a transporting system for transporting the carcasses along a processing line. More specifically, the present invention concerns a shackle for retaining and associating a poultry carcass with a conveyor system for transporting the carcass along a processing line, wherein the shackle includes a disengagement, or breakaway, feature in which at least a portion of the shackle carrying the carcass substantially automatically disengages from the conveyor system under a pre-established condition involving an increase in downward force, such as, for example, when the shackle becomes caught or otherwise impeded.

2. Background of the Invention

In the processing of carcasses, particularly poultry carcasses, the carcasses are typically transported along a processing line in which at least certain processing operations may be performed substantially automatically. The carcasses are suspended from shackles or other retaining devices which are, in turn, coupled or otherwise associated with a conveyor or other transporting system for transporting the carcasses relatively rapidly along the processing line.

It sometimes happens that a particular shackle becomes caught or otherwise impeded in its movement. When this occurs, the conveyor system may experience considerable forces as it attempts to continue moving the impeded shackle along the processing line. At the very least, the processing operations may be slowed or stopped altogether until the shackle can be freed or removed from the conveyor system. Furthermore, the conveyor system may be damaged, potentially requiring costly and time-consuming repairs.

### SUMMARY OF THE INVENTION

The present invention provides a shackle for retaining and associating a carcass, such as, for example, a poultry carcass, with a conveyor system for transporting the carcass along a processing line in which processing operations occur, wherein the shackle includes a disengagement, or breakaway, feature in which at least a portion of the shackle carrying the carcass substantially automatically disengages from the conveyor system under a pre-established condition, which, in one embodiment, involves an increase in downward force, such as, for example, when the shackle becomes caught or otherwise impeded.

In one embodiment, the shackle comprises a suspension member, and a hanger assembly adapted to retain the carcass. The hanger assembly presents an opening for receiving the suspension member, and a widenable gap, defined by first and second arms, extending between the opening and an edge of the hanger assembly. The arms are adapted to bend or otherwise separate to cause the gap to substantially automatically widen under a pre-established condition, thereby allowing the suspension member to pass through the widened gap to disengage the hanger assembly from the suspension member. In one contemplated application involving standard chicken carcasses undergoing conventional processing, the pre-established condition is a downward force applied to the hanger assembly of approximately between 150 pounds and 250 pounds.

In this embodiment, the suspension member is an upper hanger assembly, but in an alternative embodiment the suspension member may be the conveyor system itself or an extension thereof.

These and other novel features of the present invention are described in more detail in the section titled DETAILED DESCRIPTION OF THE INVENTION, below.

### BRIEF DESCRIPTION OF THE DRAWINGS

A preferred embodiment of the present invention is described in detail below with reference to the attached drawing figures, wherein:

FIG. 1 is a fragmentary front elevation view of a first embodiment of the shackle of the present invention, wherein an upper hanger assembly is shown disengaged from a lower hanger assembly;

FIG. 2 is a fragmentary front elevation view of the shackle of FIG. 1, wherein the upper hanger assembly is shown engaged with the lower hanger assembly;

FIG. 3 is a fragmentary side elevation view of a hanger hook of the upper hanger assembly engaged with first and second arms of the lower hanger assembly;

FIG. 4 is a fragmentary front elevation view of a second embodiment of the shackle of the present invention, wherein the first and second arms cooperate directly with a conveyor system; and

FIG. 5 is a fragmentary elevation view of a third embodiment of the shackle of the present invention, wherein the first and second arms define a narrowable gap.

### DETAILED DESCRIPTION OF THE INVENTION

With reference to the figures, a shackle is herein described, shown, and otherwise disclosed in accordance with a preferred embodiment of the present invention. Broadly, the present invention concerns a shackle 10 for retaining and associating a carcass, such as, for example, a poultry carcass, with a conveyor or other transporting system for transporting the carcass along a processing line in which processing operations occur, wherein the shackle 10 includes a disengagement, or breakaway, feature in which at least a portion of the shackle 10 carrying the carcass substantially automatically disengages from the conveyor system under a pre-established condition, which, in one embodiment, involves an increase in downward force, such as, for example, when the shackle becomes caught or otherwise impeded.

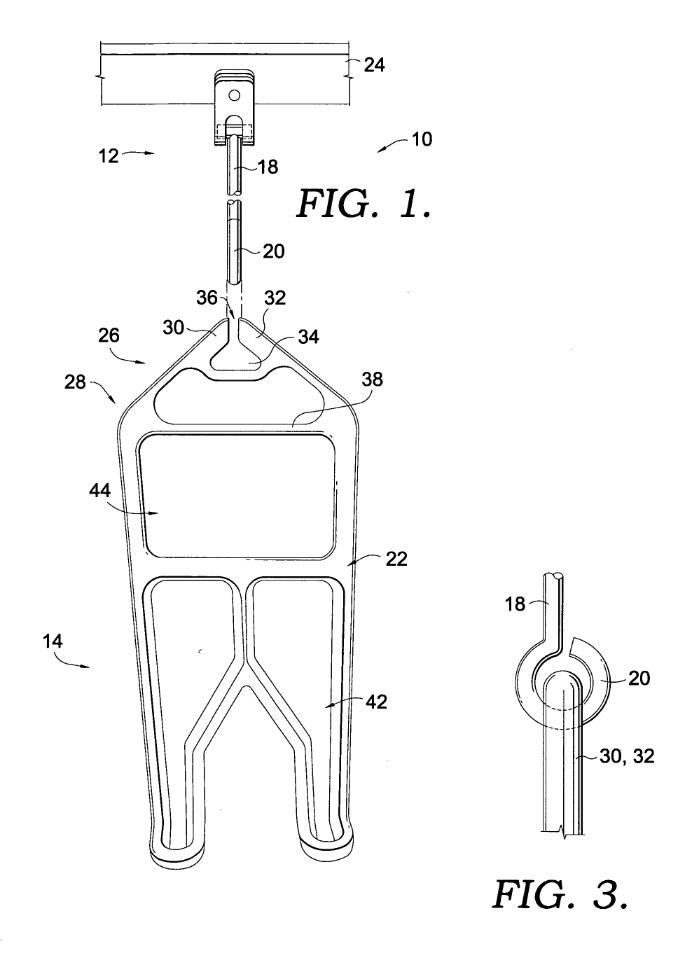

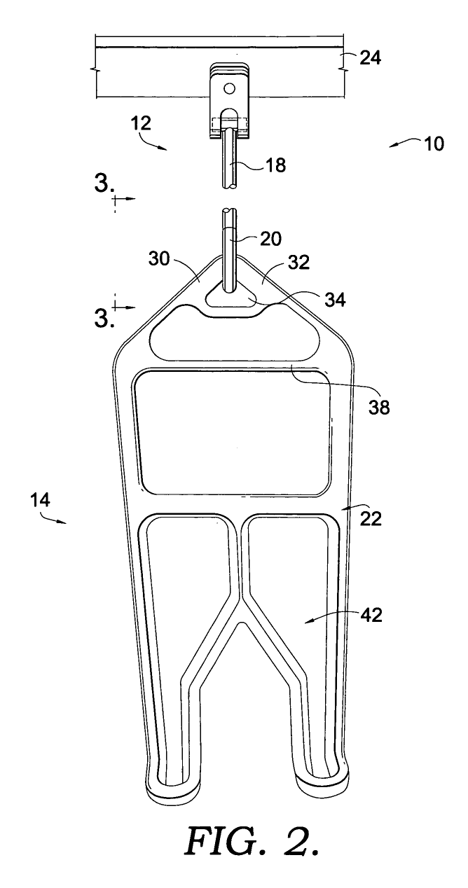

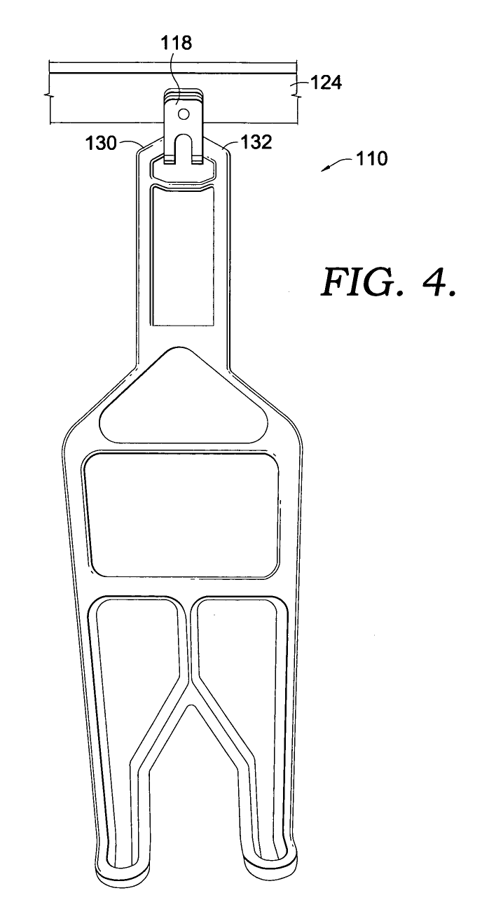

Referring to FIGS. 1, 2, and 3, an embodiment of the shackle 10 comprises an upper hanger assembly 12, including a hanger rod 18 and a hanger hook 20, and a lower hanger assembly 14, including a carcass hanger 22. The present invention is primarily concerned with the disengagement feature which, in the present first embodiment, is associated with the structure and manner of cooperation between the upper and lower hanger assemblies 12, 14, and, in a second embodiment, shown in FIG. 4 and described below, is associated with the structure and manner of cooperation between the shackle 110 and the conveyor system 124. The present invention is not primarily concerned with other details of the assemblies 12, 14, though such other details may be described and/or shown in order to provide context for the present invention.

The upper hanger assembly 12 is adapted to act as a suspension member to suspend or otherwise associate the lower hanger assembly 14 and the carcass hung or otherwise retained thereon from or with the conveyor or other transporting system 24 for transporting the carcass along the processing line. The hanger rod 18 presents first and second ends, with the first end being adapted to engage or otherwise cooperate, releasably or non-releasably, with the conveyor system 24, and with the second end presenting the hanger hook 20. The hanger hook 20 includes a curved or angled portion adapted to engage or otherwise cooperate with the lower hanger assembly 14. The hanger rod 18 and hanger hook 20 may be constructed of stainless steel or substantially any other suitable material or combination of materials, and may be cylindrical, polygonal, or substantially any other suitable shape or combination of shapes in cross-section. In one contemplated application involving standard chicken carcasses undergoing conventional processing, the hanger rod 18 and hanger hook 20 are formed from a single elongated, substantially cylindrical rod approximately between 7 mm and 9 mm in cross-sectional diameter.

The lower hanger assembly 14 is adapted to suspend or otherwise associate the carcass from or with the upper hanger assembly 12 in a desired orientation or other position to facilitate transportation along the processing line. The carcass hanger 22 presents a first portion 26 and second portion 28. The first portion 26 includes opposed first and second arms 30, 32 that define an opening 34 and that define a widenable gap 36 extending between the opening 34 and an edge of the lower hanger assembly 14. The opening 34 receives the hanger hook 20. The widenable gap 36 is, under normal operating conditions, smaller than the hanger hook 20, such that the hanger hook 20 is maintained in the opening 34 once received therein. Under the pre-established disengagement condition, however, the gap 36 widens to allow the hanger hook 20 to pass therethrough, thereby disengaging the lower hanger assembly 14 from the upper hanger assembly 12 and effectively removing the lower hanger assembly 14 and the carcass retained thereon from the conveyor system 24 and processing line.

In the present embodiment, this widening of the gap 36 is accomplished by constructing the first and second arms 30, 32 to flex or otherwise bend upwardly or sidewardly by a sufficient amount to release the hanger hook 20 when a threshold amount of separation force is applied to the lower hanger assembly 14. This bending is accomplished by constructing at least the first and second arms 30, 32, if not the entire carcass hanger 22, from a synthetic polymer, such as, for example, nylon, or other suitable natural or synthetic material or combination of materials, which further allow the first and second arms to 30, 32 to substantially automatically return to their unbended states after disengagement from the hanger hook 20.

The first and second arms 30, 32 may be connected by a crossmember 38 that both further defines the opening 34 and assists in controlling the widening of the gap 36 by assisting in controlling the upward or sideward bending of the first and second arms 30, 32.

It is also contemplated, however, that, in other embodiments, one or both of the first and second arms 30, 32 may be constructed of a breakable material or combination of materials that do not allow for reuse, or from a bendable material or combination of materials, such as, for example, a metal or metal alloy, that must be substantially manually returned, by, e.g., bending, to an operating position or shape prior to reuse.

The size of the gap 36 and the threshold amount of separation force will vary depending on such factors as, for example, the type and weight of the carcass and the particular processing steps performed on the carcass. In one contemplated application involving standard chicken carcasses undergoing conventional processing, the minimum amount of separation force may be approximately between 150 pounds and 250 pounds. Larger or smaller carcasses, such as those of turkeys, geese, ducks, or doves, may require correspondingly higher or lower minimum separation forces.

The second portion 28 presents one or more openings 42, sometimes referred to as “stirrups,” for receiving and retaining an appendage, such as, for example, the legs, or other portion of the carcass so as to maintain the carcass in the aforementioned desired orientation or other position.

Any portion of the shackle 10, particularly the carcass hanger 22, may, as appropriate, be provided with openings 44 or voids or may be made relatively thinner or otherwise adapted in order to reduce the amount of material needed to construct the portion and thereby reduce the construction cost or operating weight of the portion.

In exemplary use and operation, the present embodiment of the shackle 10 may function as follows. To begin, the upper hanger assembly 12 is engaged with the conveyor system 24, and the lower hanger assembly 14 is engaged with the upper hanger assembly 12. More specifically, the hanger hook 20 is received and maintained within the opening 34 defined by the first and second arms 30, 32 of the first portion 26 of the carcass hanger 22. A carcass is hung from the carcass hanger 22, and the shackle 10 and carcass are transported along the processing line. At some point, the shackle becomes caught or is otherwise impeded, which results in a downward force on the shackle 10 which can slow or stop, and possibly even damage, the conveyor system 24. When the downward force meets or exceeds the separation force, the first and second arms 30, 32 bend sufficiently to cause the gap 36 to widen sufficiently for the hanger hook 20 to pass through the widened gap 36 and thereby substantially automatically disengage the lower hanger assembly 14 from the upper hanger assembly 12. Once such disengagement, or breakaway, occurs, the conveyor system 24 can resume normal travel along the processing line.

From the preceding description, it will be understood and appreciated that the present invention provides a number of advantages over the prior art, including, for example, substantially automatically disengaging a caught or otherwise impeded shackle from the conveyor system and thereby allowing the conveyor system to resume normal travel along the processing line and substantially avoiding damage to the conveyor system.

Although the invention has been described with reference to the preferred embodiment illustrated in the attached drawing figures, it is noted that equivalents may be employed and substitutions made herein without departing from the scope of the invention as recited in the claims.

For example, it should be understood and appreciated that the upper hanger assembly, and especially the hanger rod and hook thereof, can be characterized as being any suitable suspension member from which the lower hanger assembly can be suspended from or otherwise associated with the conveyor system, and need not take the particular form described above and shown in FIGS. 1-3. Thus, for example, an opening, or even a recess, in a surface of the conveyor itself, or in an extension from the surface of the conveyor, adapted to cooperate with the lower hanger assembly, especially the first and second arms thereof, in the same or an equivalent manner as the upper hanger assembly cooperates with the lower hanger assembly in the above-described embodiment, would serve in the same capacity as the upper hanger assembly, i.e., as a suspension member, and therefore fall within the contemplated scope of the present invention. One such alternative second embodiment is shown in FIG. 4 in which the upper hanger assembly is eliminated or combined with the lower hanger assembly such that the first and second arms 130,132 of the shackle 110 cooperate directly with the conveyor system 124. In all other structural respects, and in function, this second embodiment of the shackle 110 may be substantially similar or even identical to the first embodiment of the shackle 10.

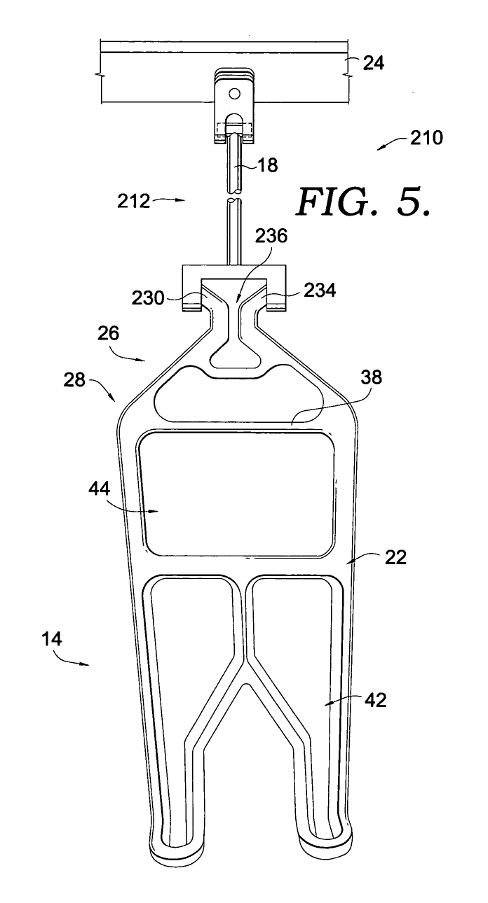

Referring to FIG. 5, a third embodiment of the shackle 210 is shown which may be substantially similar to the first or second embodiments described above, except for the following differences. Whereas in the first and second embodiments the first and second arms 30, 34 define a widenable gap 36, in the third embodiment the first and second arms 230,234 define a narrowable gap 236. More specifically, the downward force causes the arms 230,234 to converge rather than separate, thereby narrowing the gap 236 between the arms 230,234 and allowing the arms 230,236 to disengage from the upper hanger assembly 212.

Thus, it will be appreciated that, in all three embodiments, the arms bend in response to the downward force, which changes the size of the gap defined by the arms and thereby substantially automatically disengages at least a portion of the shackle from the conveyor system.

Having thus described the preferred embodiment of the invention, what is claimed as new and desired to be protected by Letters Patent includes the following:

1. A shackle for retaining a carcass, the shackle comprising:
a suspension member; and
a hanger assembly adapted to retain the carcass, and having a bendable first arm and a bendable second arm for cooperating with the suspension member, wherein the bendable first arm and the bendable second arm define a gap,
wherein the gap changes in size as the bendable first arm and the bendable second arm bend under a pre-established condition and thereby substantially automatically disengages the hanger assembly from the suspension member.

2. The shackle as set forth in claim 1, wherein the carcass is a poultry carcass.

3. The shackle as set forth in claim 2, wherein the hanger assembly is adapted to receive and retain one or more appendages of the poultry carcass.

4. The shackle as set forth in claim 3, wherein the hanger assembly is adapted to maintain the poultry carcass in a desired position.

5. The shackle as set forth in claim 1, wherein the suspension member is associated with a conveyor system for transporting the carcass.

6. The shackle as set forth in claim 1, wherein the gap widens under the pre-established condition.

7. The shackle as set forth in claim 1, wherein the gap narrows under the pre-established condition.

8. The shackle as set forth in claim 1, further including a crossmember extending between the bendable first arm and the bendable second arm and assisting in controlling the bending of the bendable first arm and the bendable second arm.

9. The shackle as set forth in claim 1, wherein the pre-established condition is a downward force applied to the hanger assembly equivalent to approximately between 150 pounds and 250 pounds.

10. A shackle for retaining a carcass, the shackle comprising:
a suspension member; and
a hanger assembly adapted to retain the carcass, and having an opening for receiving the suspension member and a widenable gap extending between the opening and an edge of the hanger assembly,
wherein the widenable gap is adapted to substantially automatically widen under a pre-established condition, thereby allowing the suspension member to pass through the widenable gap to disengage the hanger assembly from the suspension member.

11. The shackle as set forth in claim 10, wherein the carcass is a poultry carcass.

12. The shackle as set forth in claim 11, wherein the hanger assembly is adapted to receive and retain one or more appendages of the poultry carcass.

13. The shackle as set forth in claim 12, wherein the hanger assembly is adapted to maintain the poultry carcass in a desired position.

14. The shackle as set forth in claim 10, wherein the suspension member is associated with a conveyor system for transporting the carcass.

15. The shackle as set forth in claim 10, wherein the widenable gap is defined by a first arm and a second arm that bend under the pre-established condition to widen the widenable gap.

16. The shackle as set forth in claim 15, wherein the first arm and the second arm are constructed of a bendable material adapted to bend under the pre-established condition and to substantially automatically unbend following cessation of the pre-established condition.

17. The shackle as set forth in claim 15, further including a crossmember extending between the first arm and the second arm and assisting in controlling the bending of the first arm and the second arm and therefore the widening of the widenable gap.

18. The shackle as set forth in claim 10, wherein the pre-established condition is a downward force applied to the hanger assembly equivalent to approximately between 150 pounds and 250 pounds.

19. A poultry shackle for retaining a poultry carcass, the shackle comprising:
an upper hanger assembly adapted to engage a conveyor system for transporting the poultry carcass, and the upper hanger assembly including a hook; and
a lower hanger assembly adapted to retain the poultry carcass and having an opening for receiving the hook and a widenable gap extending between the opening and an edge of the lower hanger assembly,
wherein the widenable gap is adapted to substantially automatically widen under a pre-established condition involving a downward force being applied to the lower hanger assembly, thereby allowing the hook to pass through the widenable gap to disengage the upper hanger assembly from the lower hanger assembly.

20. The poultry shackle as set forth in claim 19, wherein the lower hanger assembly is adapted to receive and retain one or more appendages of the poultry carcass.

21. The poultry shackle as set forth in claim 20, wherein the lower hanger assembly is adapted to maintain the poultry carcass in a desired position.

22. The poultry shackle as set forth in claim 19, wherein the gap is defined by a first arm and a second arm that bend under the pre-established condition to widen the widenable gap.

23. The poultry shackle as set forth in claim 22, wherein the first arm and the second arm are constructed of a bendable material adapted to bend under the pre-established condition and to substantially automatically unbend following cessation of the pre-established condition.

24. The poultry shackle as set forth in claim 22, further including a crossmember extending between the first arm and the second arm and assisting in controlling the bending of the first arm and the second arm and therefore the widening of the widenable gap.

25. The poultry shackle as set forth in claim 19, wherein the downward force is equivalent to approximately between 150 pounds and 250 pounds.

26. A poultry shackle for retaining a poultry carcass, the shackle comprising:
an upper hanger assembly adapted to engage a conveyor system for transporting the poultry carcass, the upper hanger assembly including a hook; and
a lower hanger assembly adapted to retain the poultry carcass, and having an opening for receiving the hook and a widenable gap extending between the opening and an edge of the lower hanger assembly, and further having a first arm and a second arm that define the widenable gap and that bend under the pre-established condition to widen the widenable gap,
wherein the widenable gap is adapted to substantially automatically widen under a pre-established condition involving a downward force being applied to the lower hanger assembly, thereby allowing the hook to pass through the widenable gap to disengage the upper hanger assembly from the lower hanger assembly.

27. The poultry shackle as set forth in claim 26, wherein the first arm and the second arm are constructed of a bendable material adapted to bend under the pre-established condition and to substantially automatically unbend following cessation of the pre-established condition.

28. The poultry shackle as set forth in claim 26, further including a crossmember extending between the first arm and the second arm and assisting in controlling the bending of the first arm and the second arm and the widening of the widenable gap.

29. The poultry shackle as set forth in claim 26, wherein the downward force is equivalent to approximately between 150 pounds and 250 pounds.
